(19) United States
(12) Patent Application Publication
(10) Pub. No.: US 2025/0189290 A1
(43) Pub. Date: Jun. 12, 2025

(54) MOORING LINK MEASURING TOOL AND MOORING LINK MEASURING METHOD USING A MOORING LINK MEASURING TOOL

(71) Applicant: PETRÓLEO BRASILEIRO S.A. – PETROBRAS, Rio de Janeiro (BR)

(72) Inventors: Douglas Oliveira CORREA DE SOUZA, Macaé (BR); Uert Francisco DOS REIS, Macaé (BR)

(21) Appl. No.: 18/972,536

(22) Filed: Dec. 6, 2024

(30) Foreign Application Priority Data
Dec. 9, 2023 (BR) 1020230259588

(51) Int. Cl. G01B 5/08; B63B 21/00; B63B 21/20

(52) U.S. Cl. CPC G01B 5/08; B63B 21/20; B63B 2021/008

(57) ABSTRACT

The present disclosure relates to embodiments of a mooring link measuring tool comprising at least one handling rod; at least one adjustment plate; at least one graduated fork with at least two arms. Furthermore, the present disclosure relates to embodiments of a method of measuring a mooring link using the mooring link measuring tool comprising the steps of coupling at least one manipulator arm of at least one ROV to at least one handling rod; positioning the mooring link measuring tool on the mooring link; moving the mooring link measuring tool against the mooring link until the mooring link locks between at least two arms of the at least one graduated fork; measuring at least one perpendicular diameter of the mooring link; obtaining at least one image of the at least one adjustment plate positioned on the graduated fork.

### FIELD OF THE DISCLOSURE

The present disclosure falls within the technical field of inspection technologies. In particular, the present disclosure relates to a mooring link measuring tool and a mooring link measuring method using a mooring link measuring tool.

### BACKGROUND OF THE DISCLOSURE

Anchoring mooring for offshore installations, such as oil and gas industry platforms, require a high level of inspection and maintenance management in order to mitigate the risk of failures and unplanned corrective activities.

An accident involving failure of the anchoring system can result in production shutdowns, loss of the offshore installation, oil spills and release of hydrocarbons, for example.

Usually, the inspection of the mooring chain links is carried out manually and visually, with the help of a diver. In this sense, the precise measurement of the external diameter of the mooring chain link is not obtained accurately and a human resource is exposed to an activity that involves a health risk.

The precise measurement of the external diameter of the mooring link enables the calculation and analysis of fatigue, providing the definition of the occurrence of mass loss thereof.

Therefore, there is a need for a simple and easy-to-use solution with low manufacturing and maintenance costs that is capable of providing accurate measurement of the mooring link diameter, without using human resources, enabling efficient inspection of mooring links, planning of maintenance activities and corrective interventions in order to mitigate the risks of failure in the anchoring system.

### PRIOR ART

In the prior art, document EP2507583B1 discloses a mooring link thickness measuring device with a pair of arms and a display to indicate the measured distance. This document discloses a device actuated by an electric motor.

The document Subsea Caliper—Ashtead Technology Subsea Caliper is a data sheet for a commercial piece of equipment, named Subsea Caliper, which refers to an ROV-operated measuring tool for measuring a variety of subsea components, which can be deployed by ROVs (Available online at: https://www.ashtead-technology.com/wp-content/uploads/2021/06/Ashtead-Technology-Subsea-Caliper-1.pdf, file accessed on Dec. 7, 2023).

The document FlexiCal—LATERAL.NO describes an ROV-operated tool for performing mooring link measurements with instantaneous reading of the measurements. The tool has interchangeable plates and extensions for specific geometries (Available online: https://www.lateral.no/uploads/2/9/4/8/29489997/brochure_lateral_brazil.pdf, file accessed on Dec. 7, 2023).

The document Chain Measuring System reveals a system for measuring mooring links. Inter-link and link length measurements can be performed. With the tool, measurements of individual links can be obtained, monitoring wear, corrosion, and any modifications, in real time (available on the internet at: https://www.film-ocean.com/uploads/Chain-Measuring-Spec-Sheet-Rev-B.pdf, file consulted on Dec. 7, 2023).

The document Measuring caliper—EM&I describes an ROV-operated mooring chain measurement tool (available online at: https://www.emialliance.com/emi-launch-new-method-mooring-chain-inspections/, file accessed Dec. 7, 2023).

Prior art documents reveal tools that have an operating principle based on movement by the action of hydraulic pistons (EP2507583B1 and Chain Measuring System) or electric motors (Subsea Caliper—Ashtead Technology Subsea Caliper, FlexiCal—LATERAL.NO and Measuring caliper—EM&I). The present disclosure is entirely mechanical, which makes its application much simpler when compared to the prior art. Furthermore, the disclosed disclosure has a lower manufacturing cost because it is much simpler, and also has lower maintenance cost and greater reliability. It is worth highlighting that, when compared with documents EP2507583B1 and Chain Measuring System, there is no risk in relation to the environment since, when there is hydraulic activation, the fluids used are normally polluting chemical products, which can contaminate the water in cases of leakage. As it does not have electro-hydraulic actuation, it allows use by teams without the need for special training, which also makes operation simpler and safer. All the prior art presented fulfills the function of measurements with the ROV to some extent, but with greater complexity and risk to the environment when compared to the present disclosure. The method developed in the present disclosure is not disclosed by the cited documents, being also simple and efficient.

### BRIEF DESCRIPTION OF THE DISCLOSURE

According to an embodiment of the present disclosure, a mooring link measuring tool is defined comprising:
at least one handling rod;
at least one adjustment plate including at least one upper portion and at least one lower portion;
at least one graduated fork with at least two arms, wherein the graduated fork is arranged between the upper portion and the lower portion of the adjustment plate;
wherein the adjustment plate is sliding along the at least two arms;
wherein the at least two arms are spaced apart and joined at one of their ends through at least one fork base; wherein the other end of each of the at least two arms is open;
wherein at least one of the at least two arms comprises a plurality of measurement indications relating to a plurality of external diameters measurements of at least one mooring link;
wherein the distance between the at least two arms is variable along them according to the plurality of external diameter measurements of at least one mooring link.

Furthermore, according to an embodiment of the present disclosure, the at least one handling rod is operated by at least one ROV (Remoted Operated Vehicle) or by at least one diver or by at least one underwater drone.

Further, according to another embodiment of the present disclosure, the plurality of external diameter measurements of at least one mooring link comprises at least one of:
at least one measurement equal to the nominal external diameter value of at least one mooring link;
at least one measurement that represents 95% of the nominal external diameter value of at least one mooring link;
at least one measurement that represents 90% of the nominal external diameter value of at least one mooring link.

Furthermore, according to a further embodiment of the present disclosure, the at least one graduated fork comprises at least three calibration indications, including:
at least one calibration indication that represents 100% of the nominal external diameter value of the mooring link;
at least one calibration indication that represents 95% of the nominal external diameter value of the mooring link; and
at least one calibration indication that represents 90% of the nominal external diameter value of the mooring link.

Furthermore, according to another embodiment of the present disclosure, the at least one adjustment plate is fixed in a plurality of graduated fork positions through at least one fixing means on at least one end of at least one of the at least one upper portion or at least one lower portion.

According to an embodiment of the present disclosure, a method of measuring a mooring link using the mooring link measuring tool as defined above is defined, the method comprising the steps of:
coupling at least one manipulator arm of at least one ROV (Remoted Operated Vehicle) to at least one handling rod;
positioning the mooring link measuring tool on the mooring link, between the center of the parallel body of the mooring link and the crown region of the mooring link;
moving the mooring link measuring tool against the mooring link until the mooring link locks between at least two arms of the at least one graduated fork;
measuring at least one perpendicular diameter of the mooring link;
obtaining at least one image of the at least one adjustment plate positioned on the graduated fork.

Additionally, according to another embodiment of the present disclosure, before coupling at least one manipulator arm of at least one ROV (Remoted Operated Vehicle) in at least one handling rod:
carrying out a visual inspection of a plurality of mooring links;
cleaning the at least one mooring link, preferably in accordance with cleaning grade Sa2 of ABNT NBR 7348:2017 standard.

Additionally, according to a complementary embodiment of the present disclosure, the step of positioning the mooring link measuring tool on the mooring link, between the center of the parallel body of the link and the crown region of the link, comprises:
positioning the mooring link measuring tool on the mooring link sections to measure at least one perpendicular diameter of the link without twisting or tilting relative to the parallel body cross-section of the mooring link.

Furthermore, according a complementary to preferred embodiment of the present disclosure, the step of measuring at least one perpendicular diameter of the link includes:
measuring at least three measurements of at least three links comprising:
at least one first link below the fairlead;
at least a second link 30 meters from the LDA; and
at least one third link intermediate to at least one first link and to at least one second link.

Additionally, according to another complementary embodiment of the present disclosure, the step of moving the mooring link measuring tool against the link until the link locks between at least two arms of the at least one graduated fork comprises:
moving the adjustment plate so that it slides along the two arms and is arranged in one position of the graduated fork.

Furthermore, according to another complementary embodiment of the present disclosure, the adjustment plate is positioned on the graduated fork at a plurality of measurement indications, wherein the plurality of measurement indications comprises a plurality of external diameters measurements of at least one mooring link.

### BRIEF DESCRIPTION OF THE FIGURES

In order to complement the present description and obtain a better understanding of the characteristics of the present disclosure, and in accordance with a preferential embodiment thereof, a set of figures is presented in annex, where in an exemplified way, although not limiting, it represents the preferred embodiment.

FIG. 1 shows an illustrative diagram of the mooring link measuring tool, according to an embodiment of the present disclosure.

FIG. 2 illustrates the mooring link measuring tool with a plurality of measurement indications, according to an embodiment of the present disclosure.

FIG. 3 is an example of the graduated fork of the mooring link measuring tool with a plurality of measurement indications according to an embodiment of the present disclosure.

FIG. 4 shows the mooring link measuring tool used on a 108 mm calibration billet, according to an embodiment of the present disclosure.

FIG. 5 shows the mooring link measuring tool used on a 114 mm calibration billet, according to an embodiment of the present disclosure.

FIG. 6 represents the mooring link measuring tool used on a 120 mm calibration billet, according to an embodiment of the present disclosure.

FIG. 7 shows a demonstration of the appropriate and necessary level of cleaning of a mooring link according to an embodiment of the present disclosure.

FIG. 8 illustrates an example of at least three mooring links to be measured with the mooring link measuring tool and method according to an embodiment of the present disclosure.

FIG. 9 shows the measurement region of at least one mooring link diameter according to an embodiment of the present disclosure.

FIG. 10 shows the suitable measurement region of at least one diameter of the mooring link according to an embodiment of the present disclosure.

FIG. 11 shows an illustrative diagram of suitable and unsuitable positions for measuring the mooring link according to an embodiment of the present disclosure.

FIG. 12 illustrates an example of the mooring link measuring tool with the adjustment plate positioned on the graduated fork according to an embodiment of the present disclosure.

FIG. 13 shows an example of calibration with a billet having an external diameter equal to the nominal external diameter of a mooring link according to an embodiment of the present disclosure.

FIG. 14 shows an example of calibration with a billet having an external diameter equal to 95% of the nominal external diameter of a mooring link according to an embodiment of the present disclosure.

FIG. 15 shows an example of calibration with a billet with an external diameter equal to 90% of the nominal external diameter of a mooring link according to an embodiment of the present disclosure.

### DETAILED DESCRIPTION OF THE DISCLOSURE

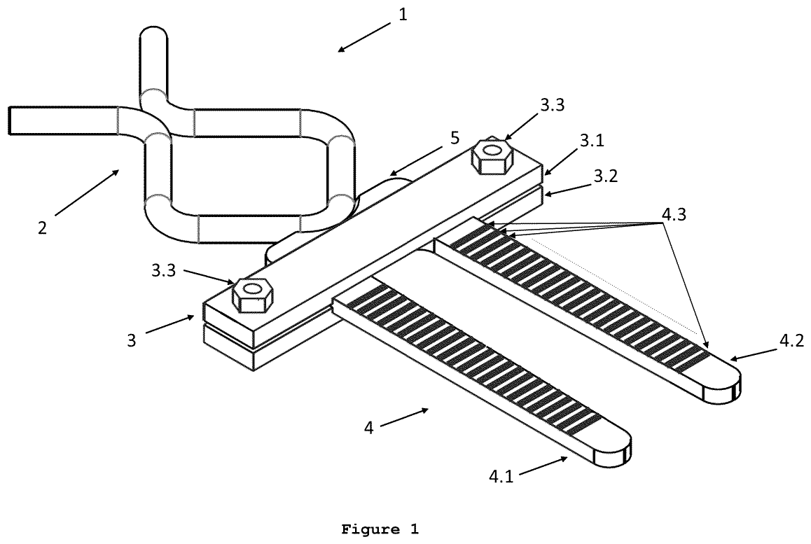

FIG. 1 shows an illustrative diagram of the mooring link measuring tool 1, according to according to an embodiment of the present disclosure.

Specifically, the mooring link measuring tool 1 comprises at least one handling rod 2, at least one adjustment plate 3 and at least one graduated fork 4.

The at least one handling rod 2 may be operated by at least one ROV (Remoted Operated Vehicle), specifically, by at least one manipulated arm of the ROV or by at least one diver or by at least one underwater drone, to allow the mooring link measuring tool 1 to be moved to the mooring link. Furthermore, the ROV coupled to the handling rod 2 enables the correct positioning of the mooring link measuring tool 1 in the mooring link sections to measure at least one perpendicular diameter D1, D2 of the link, without twisting or tilting the mooring link measuring tool 1 relative to the cross section of the mooring link parallel body.

The adjustment plate 3 includes at least two portions: at least an upper portion 3.1 and at least a lower portion 3.2.

The graduated fork 4 is arranged between the upper portion 3.1 and the lower portion 3.2 of the adjustment plate 3.

Specifically, the graduated fork 4 includes at least two arms 4.1, 4.2, wherein the at least two arms 4.1, 4.2 are spaced apart and joined at one of their ends through at least one base of the fork 5, while the other end of each of the at least two arms 4.1, 4.2 is open. The open end of each of the at least two arms 4.1, 4.2 serves to allow the mooring link measurement to be carried out, whereby the mooring link can travel through the space between the at least two arms 4.1, 4.2.

In particular, at least one of the at least two arms 4.1, 4.2 of the graduated fork 4 comprises a plurality of measurement indications 4.3, wherein the plurality of measurement indications 4.3 comprises a plurality of external diameters measurements 4.3, in particular of external diameters of at least one mooring link to be inspected.

In this sense, with respect to the at least two arms 4.1, 4.2 of the graduated fork 4, the distance between the at least two arms 4.1, 4.2 is variable along the same.

Specifically, the distance between the at least two arms 4.1, 4.2 is variable along them according to the plurality of external diameters measurements 4.3 of at least one mooring link included in at least one of the at least two arms 4.1, 4.2 as the plurality of indications of measurements 4.3.

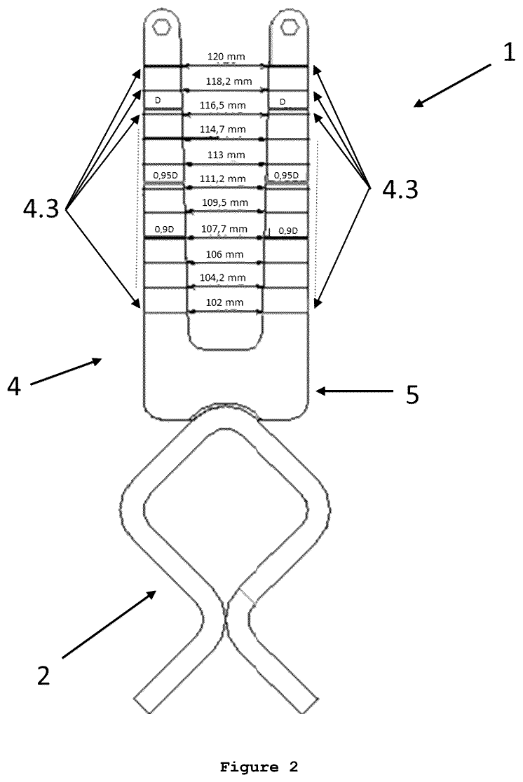

FIG. 2 illustrates an example of a mooring link measuring tool 1 according to an exemplary embodiment of the present disclosure, where it is possible to observe that the distance between the at least two arms 4.1, 4.2 of the graduated fork 4 is variable along them, according to the plurality of external diameter measurements 4.3 referring to the plurality of measurement indications 4.3 included in at least one of the at least two arms 4.1, 4.2.

For example, according to FIG. 2, the at least two arms 4.1, 4.2 are arranged distant from each other in the following measurements, along them, seen from the joined ends of the arms (4.1, 4.2): 102 mm, 104.2 mm, 106 mm, 107.7 mm, 109.5 mm, 111.2 mm, 113 mm, 114.7 mm, 116.5 mm, 118.2 mm and 120 mm.

In this sense, the distance between the at least two arms 4.1, 4.2 is defined according to a plurality of external diameters measurements 4.3 of at least one mooring link to be measured, for example, the plurality of external diameters measurements 4.3 of at least one mooring link comprises at least one of:
at least one measurement that represents approximately 100% or 100% of the nominal external diameter value of the at least one mooring link to be measured, that is, a measurement indication that is substantially equal to the nominal external diameter value of the mooring link;
at least one measurement that represents approximately 95% or 95% of the nominal external diameter value of at least one mooring link;
at least one measurement that represents approximately 90% or 90% of the nominal external diameter value of the mooring link.

Additionally, as can be seen in FIG. 2, the graduated fork 4 comprises at least three calibration indications, including: at least one calibration indication that represents 100% of the nominal external diameter D value of the mooring link; at least one calibration indication that represents 95% of the nominal external diameter 0.95D value of the mooring link; and at least one calibration indication that represents 90% of the nominal external diameter 0.9D value of the mooring link.

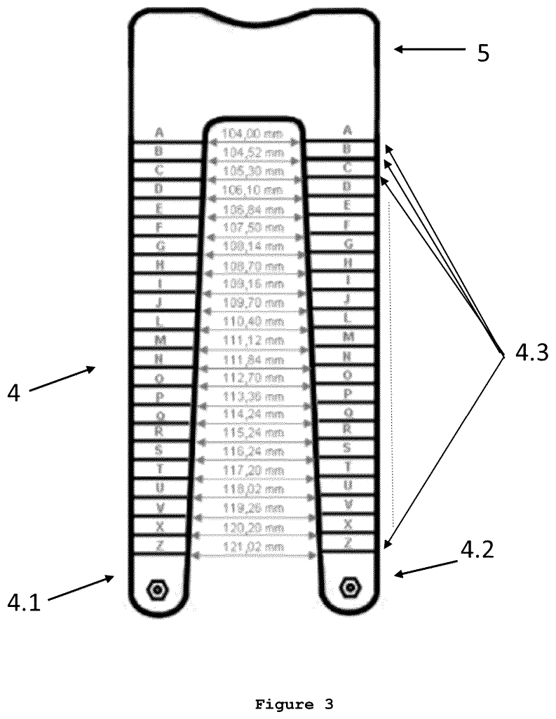

In addition, FIG. 3 represents another example of the graduated fork 4 of the mooring link measuring tool 1 with a plurality of measurement indications 4.3 on the at least two arms 4.1, 4.2. As can be seen in this example in FIG. 3, the plurality of measurement indications 4.3 is indicated in the form of letters, from A to Z, where each letter corresponds to a measurement value. Any other type of correspondence between symbol or letter and the measurement value can be used. Therefore, the correspondence between each of the plurality of measurement indications 4.3 with the plurality of external diameter measurements 4.3 must be recorded in a specific report.

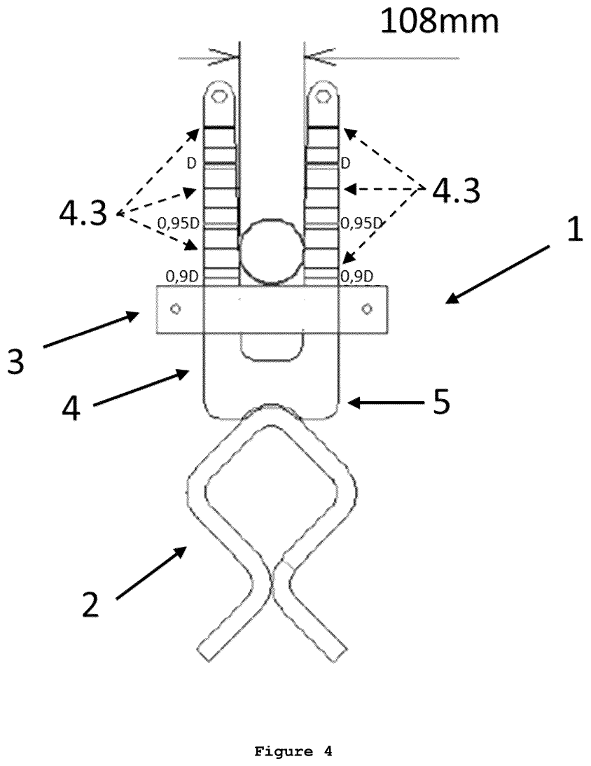

FIGS. 4, 5 and 6 show additional examples of the mooring link measuring tool 1 in accordance with exemplary embodiments of the present disclosure.

FIG. 4 shows the mooring link measuring tool 1 according to an exemplary embodiment of the present disclosure, wherein a calibration billet is positioned in the spacing between the at least two arms 4.1, 4.2 of the graduated fork 4. As can be seen in this illustrative display, the billet has an external diameter of 108 mm, which represents 90% of the nominal external diameter of a mooring link to be measured, wherein the nominal external diameter of the mooring link to be measured is 120 mm.

It should be noted that, although calibration was mentioned, a skilled in the art has sufficient skills to understand that calibration can be understood as the practical application of tool 1 for measuring a mooring link.

Additionally, as can be seen in FIG. 4, during the calibration procedure of the tool 1 or its use for measurement, the calibration billet moved along the at least two arms 4.1, 4.2 of the graduated fork 4 and stopped at the position corresponding to the measurement of its external diameter (that is, 108 mm), where there is a measurement indication 4.3 of the plurality of measurement indications 4.3 on at least one of the at least two arms 4.1, 4.2.

Thus, the adjustment plate 3 is slid along the two arms 4.1, 4.2 until the calibration billet stops and locks in a position corresponding to the measurement of its external diameter, where there is a measurement indication 4.3 on at least one of the at least two arms 4.1, 4.2, causing the mooring link measuring tool 1 to remain immobile, and the adjustment plate 3 to be positioned on the graduated fork 4. According to FIG. 4, the adjustment plate 3 is positioned on the graduated fork 4, at the calibration indication that represents 90% of the nominal external diameter 0.9D of the mooring link.

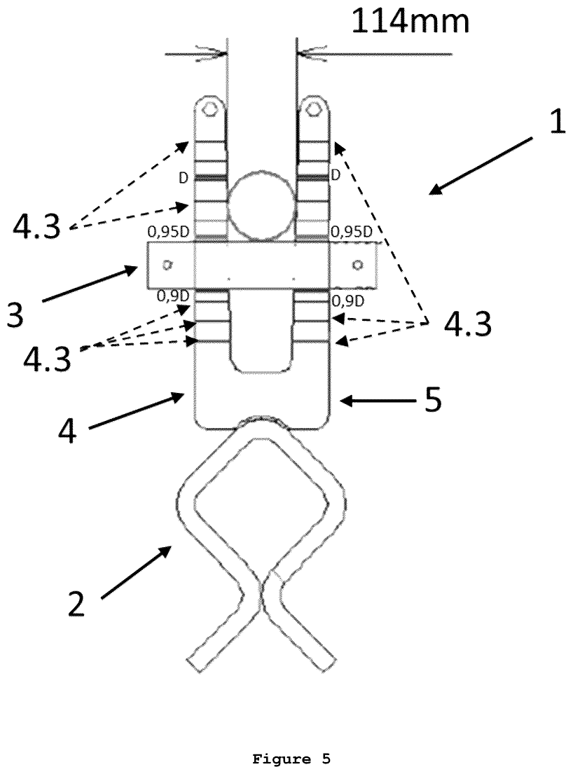

Analogously to FIG. 4, FIG. 5 shows the mooring link measuring tool 1 according to another exemplary embodiment of the present disclosure, wherein a calibration billet is positioned between the at least two arms 4.1, 4.2 of the graduated fork 4. As can be seen in this illustrative display, the billet has an external diameter of 114 mm, which represents 95% of the nominal external diameter of a mooring link to be measured, wherein the nominal external diameter of the mooring link to be measured is 120 mm.

Furthermore,, as can be seen in FIG. 4, during the calibration procedure of the tool or its use for measurement, the calibration billet moved along the at least two arms 4.1, 4.2 of the graduated fork 4 and stopped at the position corresponding to the measurement of its external diameter (that is, 114 mm), where there is a measurement indication 4.3 of the plurality of measurement indications 4.3 on at least one of the at least two arms 4.1, 4.2.

Thus, the adjustment plate 3 is slid along the two arms 4.1, 4.2 until the calibration billet stops and locks in a position corresponding to the measurement of its external diameter, where there is a measurement indication 4.3 on at least one of the at least two arms 4.1, 4.2, causing the mooring link measuring tool 1 to remain immobile, and the adjustment plate 3 to be positioned on the graduated fork 4. According to FIG. 5, the adjustment plate 3 is positioned on the graduated fork 4, at the calibration indication that represents 95% of the nominal external diameter 0.95D of the mooring link.

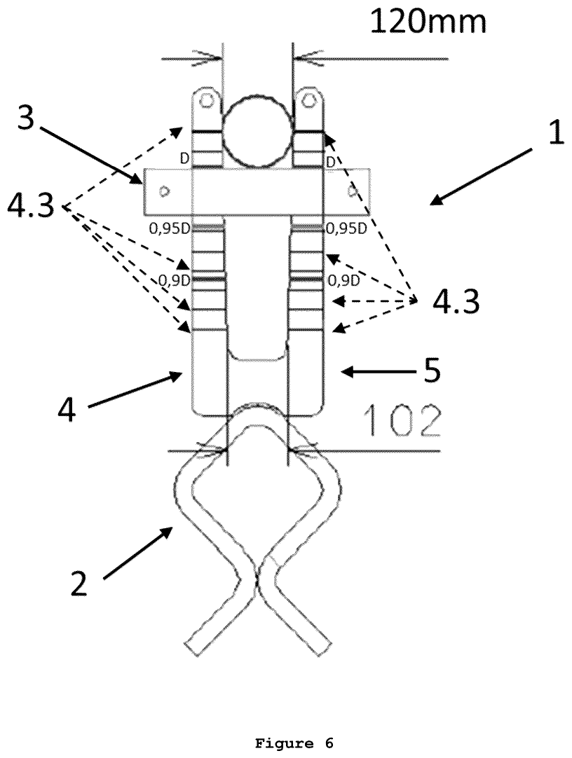

Similar to FIG. 4 and FIG. 5, FIG. 6 shows the mooring link measuring tool 1 according to another exemplary embodiment of the present disclosure, wherein a calibration billet is positioned between the at least two arms 4.1, 4.2 of the graduated fork 4. As can be seen in this illustrative display, the billet has an external diameter of 120 mm, which represents 100% of the nominal external diameter of a mooring link to be measured, wherein the nominal external diameter of the mooring link to be measured is 120 mm.

Furthermore, as can be seen in FIG. 6, during the calibration procedure of the tool 1 or its use for measurement, the calibration billet moved along the at least two arms 4.1, 4.2 of the graduated fork 4 and stopped at the position corresponding to the measurement of its external diameter (that is, 120 mm), where there is a measurement indication 4.3 of the plurality of measurement indications 4.3 on at least one of the at least two arms 4.1, 4.2.

Accordingly, the adjustment plate 3 is slid along the two arms 4.1, 4.2 until the calibration billet stops and locks in a position corresponding to the measurement of its external diameter, where there is a measurement indication 4.3 on at least one of the at least two arms 4.1, 4.2, causing the mooring link measuring tool 1 to remain immobile, and the adjustment plate 3 to be positioned on the graduated fork 4. According to FIG. 6, the adjustment plate 3 is positioned on the graduated fork 4, at the calibration indication that represents 100% of the nominal external diameter D of the mooring link.

Thus, the adjustment plate 3 can be movable or sliding along the two arms 4.1, 4.2 of the graduated fork 4. In particular, the adjustment plate 3 can be positioned on a plurality of measurement indications 4.3, wherein the plurality of measurement indications 4.3 comprises a plurality of measurements of external diameters 4.3, in particular of external diameters of at least one mooring link to be inspected.

Furthermore, the adjustment plate 3 can be fixed in a plurality of positions of the graduated fork 4. The fixing of the adjustment plate 3 in a plurality of positions of the graduated fork 4 can be carried out by using at least one fixing means 3.3 at least one end of at least one of the at least two upper 3.1 or lower 3.2 portions. Specifically, the at least one fixing means 3.3 may be at least one bolt with nut and washer.

According to the mooring link measuring tool 1 of the present disclosure, unlike actuated calipers, where one end is movable, the measurement profile referenced to the nominal external diameter of the mooring link must be followed, that is, the mooring link measuring tool 1 of the present disclosure has measurement indications compatible with the nominal external diameter of the mooring link to be measured/inspected.

With regard to the materials used in the construction of the mooring link measuring tool 1 and its components, it is understood that these may vary, ensuring, however, that the sliding adjustment plate 3 is locked in the graduated fork 4, assuring orthogonality of the adjustment plate 3 in relation to the at least two arms 4.1, 4.2 of the graduated fork 4.

Additionally, according to another preferred embodiment of the present disclosure, a method of measuring a mooring link using the mooring link measuring tool 1, as described above, is defined.

The method of measuring the mooring link using the mooring link measuring tool 1 as described above comprises the following steps:
coupling at least one manipulator arm of at least one ROV (Remoted Operated Vehicle) to at least one handling rod 2;
positioning the mooring link measuring tool 1 on the mooring link, between the center of the parallel body 11 of the link and the crown region 12 of the link;
moving the mooring link measuring tool 1 against the link until the link locks between at least two arms 4.1, 4.2 of the at least one graduated fork 4;
measuring at least one perpendicular diameter D1, D2 of the link;
obtaining at least one image of the at least one adjustment plate 3 positioned on the graduated fork 4;
wherein the at least one measurement indication (4.3) refers to at least one external diameter measurement (4.3) of at least one mooring link.

First, a general visual inspection of the plurality of mooring links may be performed prior to coupling at least one manipulator arm of at least one ROV to at least one handling rod 2. Visual inspection includes viewing the anchoring system components with a focus on assessing their integrity. In particular, it is recommended to carried out a general visual inspection of a plurality of mooring links of the Tidal Variations Zone (ZVM—Zona de Variação das Marés) up to a depth of 30 m. Furthermore, the mooring in the fairlead region (−5 m to −15 m) should be inspected more carefully, with the ROV approaching closer, when possible. In addition, the depth at which the visual inspection ends must be recorded.

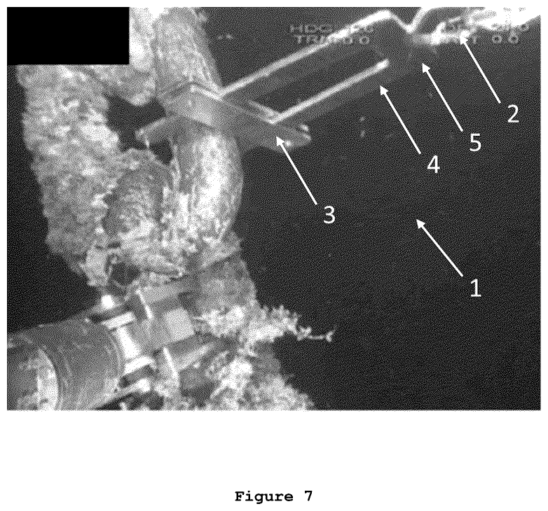

Additionally, the cleanliness condition of the mooring link to be measured must be assessed. If necessary, a cleaning step of at least one mooring link must be performed before coupling at least one manipulator arm of at least one ROV to at least one handling rod 2. The cleaning of the mooring link must meet the criteria defined in ABNT NBR 7348:2017—Industrial painting—Preparation of steel surface with abrasive blasting or hydroblasting, specifically, meet a level of cleanliness similar to Sa2, defined in said standard. In this sense, before starting the measurement, the ROV can clean the measurement section of the mooring link with a metal brush or equivalent equipment, removing soft/hard incrustations, corrosion scale, until a surface appearance similar to the Sa2 grade is obtained. Specifically, for mortise mooring, cleaning the link must be accompanied by checking its functionality, assessing whether it is loose or has apparent gap. FIG. 7 illustrates a demonstration of the proper cleanliness level of a mooring link, with the mooring link measuring tool 1 already positioned on the link.

In particular, the at least one ROV manipulator arm coupled to the at least one handling rod 2 of the mooring link measuring tool 1 enables the correct movement and positioning of the mooring link measuring tool 1.

Thus, the step of positioning the mooring link measuring tool 1 on the mooring link, between the center of the parallel body 11 of the link and the crown region 12 of the link, comprises positioning the mooring link measuring tool 1 on the sections of the mooring link for measuring at least one perpendicular diameter D1, D2 of the link without twisting or tilting relative to the cross-section of the mooring link parallel body. Additionally, another ROV manipulator arm may be available for docking or coupling the ROV to one of the links of the inspected mooring line.

Preferably, the ROV can be a work class type capable of operating in waterlines (LDA) from 0 to 30 meters. The ROV positioning system must indicate the position with accuracy up to 0.8% of LDA.

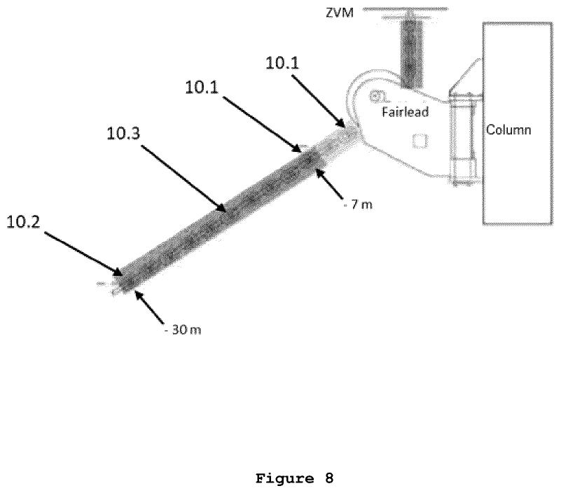

In the step of measuring at least one perpendicular diameter D1, D2 of the link, it includes measuring at least three measurements of at least three different links, as can be seen in FIG. 8, in which the at least three links 10.1, 10.2, 10.3 comprise: at least a first link 10.1 below the fairlead; or at least a first link 10.1 at the minimum waterline (LDA) that the ROV reaches, preferably at least a first link 10.1 at about seven meters (7 m) below the fairlead, that is, at −7 meters from the fairlead; at least a second link 10.2 at about 30 meters from the LDA; and at least a third link 10.3 intermediate to the at least a first link 10.1 and the at least a second link 10.2.

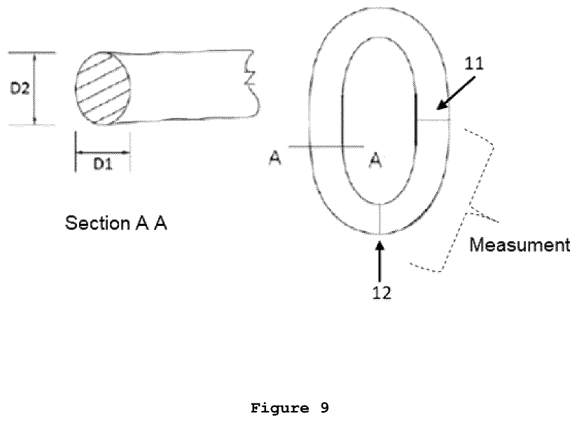

FIG. 9 shows an example of a mooring link having an indication of at least one diameter D1, D2 which can be measured by the mooring link measuring tool 1 and with the mooring link measuring method of the present disclosure.

As can be seen in FIG. 9, in particular, the measurement of at least one diameter D1, D2 of the mooring link with the mooring link measuring tool 1 of the present disclosure is preferably carried out between the center of the parallel body 11 of the link (welding region) and the crown region 12 of the link, as marked in said FIG. 9. More specifically, the at least one diameter of the mooring link to be measured with the mooring link measuring tool 1 may be at least one of: at least a first perpendicular diameter D1 or at least a second perpendicular diameter D2, as illustrated in section A-A of FIG. 9. Therefore, one should avoid positioning tool 1 in the welding region 11 located in the central portion of the link, as this region presents an increase in diameter due to the welding.

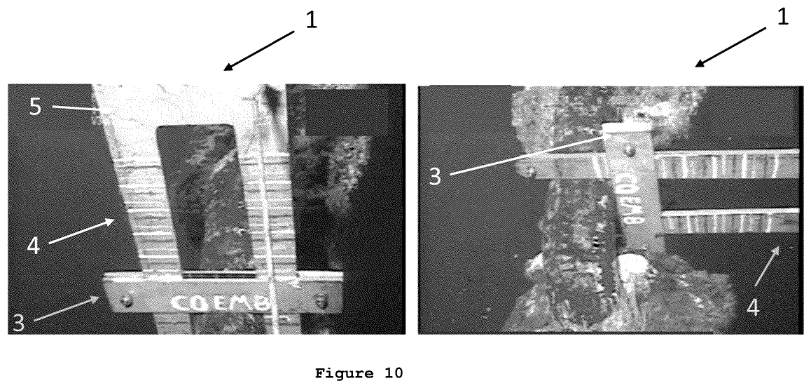

FIG. 10 illustrates the mooring link measuring tool 1 positioned on the two perpendicular axes of a mooring link. Therefore, it is important to emphasize the importance of ensuring perpendicular measurements of the diameter in the same cross section.

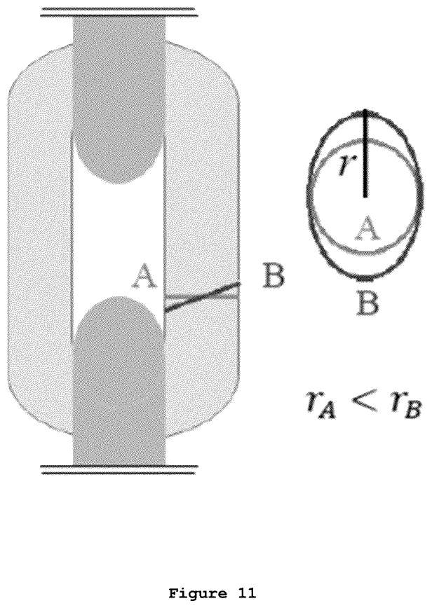

As can be clearly seen in FIG. 11, the mooring link measuring tool 1 is positioned with the aid of the ROV so that the opening between at least two arms 4.1, 4.2 of the graduated fork 4 encompasses a mooring link without there being any twisting and/or inclination relative to the cross-section of the parallel body of the mooring link, between the center of the parallel body 11 of the link and the crown region 12 of the link.

Thus, as shown in FIG. 11, the position designated as B would not be suitable for positioning the mooring link measuring tool 1 of the present disclosure. The position designated as A would be suitable for positioning the mooring link measuring tool 1 of the present disclosure. The inclination applied at the position named B generates a distortion in relation to the perpendicular position A of the circular section. Tilt deviation in position B can lead to incorrect measurement values.

When moving the mooring link measuring tool 1 on the link to perform the measurement, the mooring link measuring tool 1 must be moved by the ROV so that the tool 1 is pushed against the link, including moving the adjustment plate 3 so that it slides along the two arms 4.1, 4.2 of the graduated fork 4 until the diameter of the link being measured locks on the two arms 4.1, 4.2, thus the mooring link measuring tool 1 remains stationary and the adjustment plate 3 is positioned on the graduated fork 4.

The moment of measurement of diameters D1, D2 must be recorded, by obtaining at least one image, by filming or photography. The position of the ROV, the camera that will obtain at least one image by filming or photography and the lighting used must be such as to allow perfect visualization of the adjustment plate 3 positioned on the graduated fork 4. Furthermore, it is important to ensure a viewing angle that allows the relative position of the adjustment plate 3 on the graduated fork 4 to be identified from the open end of the graduated fork 4, without perspective errors (e.g., parallax error and shadow effect).

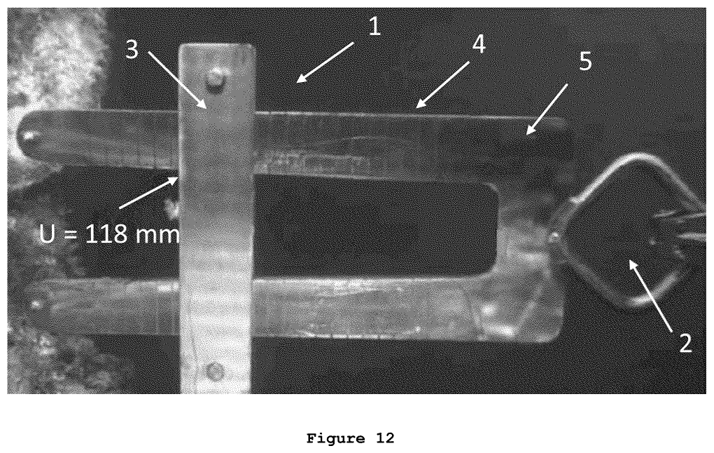

FIG. 12 illustrates an example of the mooring link measuring tool 1 with the adjustment plate 3 positioned on the graduated fork 4 at a measurement indication 4.3 labeled U=118 mm. If the inner part of the adjustment plate 3, in relation to the open ends of the at least two arms 4.1, 4.2, is positioned between one position and another, the measurement must consider the approximation to the smallest measurement between them.

Furthermore, it is preferable to carry out a step of measuring the distance between the at least three links 10.1, 10.2, 10.3 in relation to the fairlead, in which the measurement is carried out in metres and in the number of links counted from one of the at least three links 10.1, 10.2, 10.3 to the fairlead.

### Calibration of the Mooring Link Measuring Tool 1

Calibration of the mooring link measuring tool 1 used in dimensional inspection or measurement of mooring link, specifically mooring link diameter, is essential. There are two most appropriate and commonly applied calibration methods in inspection campaigns: direct calibration using billets of known diameters related to the nominal diameter of the inspected mooring link; and indirect calibration by means of a technical design named as as-built or as-laid of the mooring link measuring tool 1.

### Direct Calibration

For direct calibration, 3 calibration billets can be used: one with the external DN (nominal diameter) of the link, one with an external DN lower than that of the link and another with an external DN higher than that of the link. As illustrated in FIG. 4, FIG. 5 and FIG. 6, each of the at least two arms 4.1, 4.2 includes at least three calibration indications, including: a calibration indication that represents 100% of the nominal external diameter D value of the mooring link; a calibration indication that represents 95% of the nominal external diameter 0.95D value of the mooring link; and a calibration indication that represents 90% of the nominal external diameter 0.9D value of the mooring link. In particular, the at least three calibration indications D, 0.95D, 0.9D serve as visual reference of the ROV during subsea measurement.

Images of all calibrations must be obtained and, if warping and/or deformation are found in tool 1, it must be repaired.

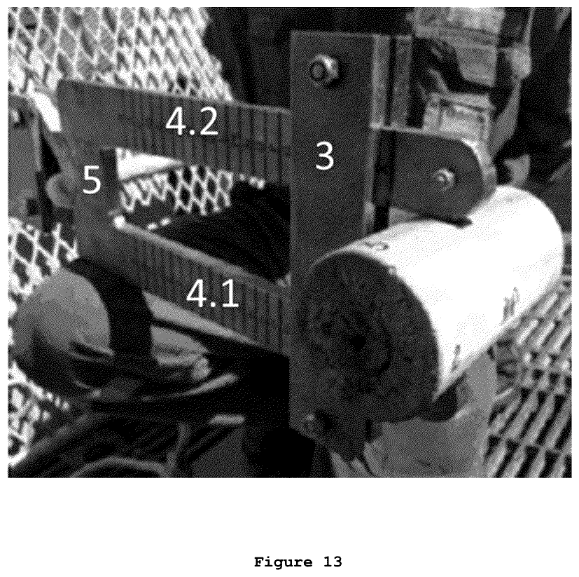

FIG. 13 illustrates an example of calibration with a billet with an external diameter equal to the nominal external diameter of a mooring link, in which the adjustment plate is positioned at the calibration indication that represents 100% of the nominal external diameter D of the mooring link.

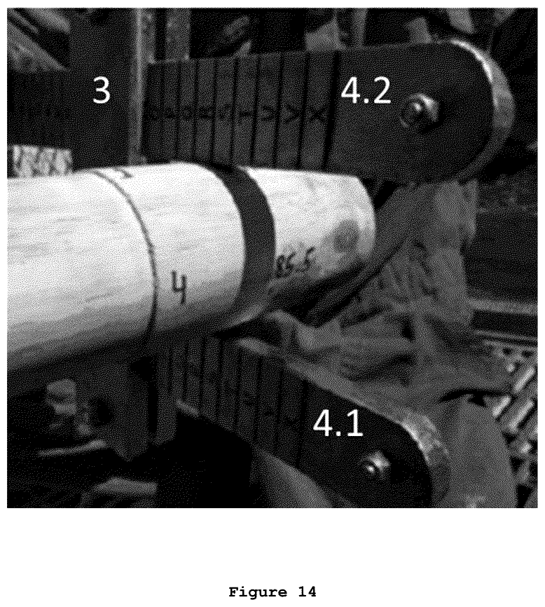

FIG. 14 illustrates an example of calibration with a billet with an external diameter equal to 95% of the nominal external diameter of a mooring link, in which the adjustment plate is positioned at the calibration indication that represents 95% of the nominal external diameter 0.95D of the mooring link.

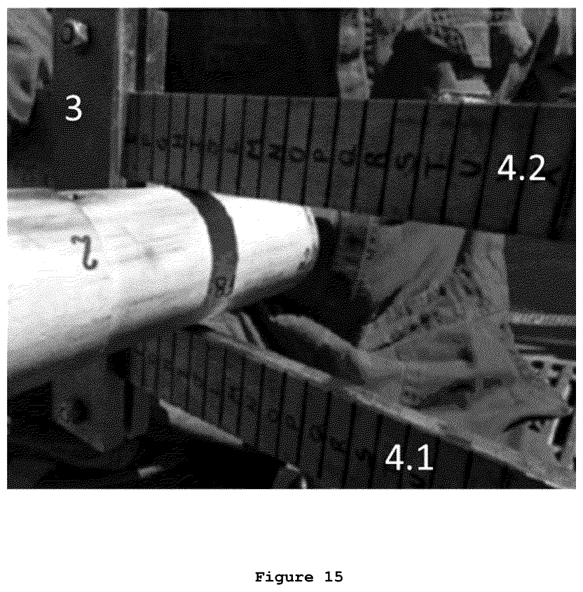

FIG. 15 illustrates an example of calibration with a billet with an external diameter equal to 90% of the nominal external diameter of a mooring link, in which the adjustment plate is positioned at the calibration indication that represents 90% of the nominal external diameter 0.9D of the mooring link. All calibrations must be recorded in a report.

### Indirect Calibration

In indirect calibration, tool 1 must be measured with suitable instruments, such as graduated calipers, to determine the accuracy of the marked values.

In the case of tool 1 of the present disclosure, an as-laid of the tool must be generated as a product of the calibration.

Similar to direct calibration, these dimensional checks of the tool must be performed to ensure the integrity and accuracy of the tool across the various measurements in an inspection campaign. The main objective is to check whether there is deformation in the tool or other failure that results in an increase in the error and inaccuracy of the measured values. If warping and/or deformation are found, the tool must be repaired, and the inspected links must be measured again. All calibrations must be recorded in a report.

As observed in FIG. 3, an advantage of the present disclosure is the method of establishing the measured dimension, since the tool forks have an angle that is related to the diameter of the link. In other words, when the mooring link touches the smallest measurement of this angular fork corresponding to its diameter, the tool no longer advances, locking its course in the position corresponding to the value of the link diameter. It means that the measurement is simpler than that reported in the prior art and this form of measurement reduces the probability of error.

Those skilled in the art will value the knowledge presented herein and will be able to reproduce the disclosure in the presented embodiments and in other variants, covered in the scope of the appended claims.

1. Mooring link measuring tool comprising:
at least one handling rod;
at least one adjustment plate including at least an upper portion and at least one lower portion; and
at least one graduated fork with at least two arms, wherein the graduated fork is arranged between the upper portion and the lower portion of the adjustment plate,
wherein the adjustment plate is sliding along the at least two arms,
wherein the at least two arms are distant from each other and joined at one of their ends through at least one fork base,
wherein the other end of each of the at least two arms is open,
wherein at least one of the at least two arms comprises a plurality of measurement indications relating to a plurality of external diameter measurements of at least one mooring link, and
wherein the distance between the at least two arms is variable along them according to the plurality of external diameter measurements of at least one mooring link.

2. Mooring link measuring tool according to claim 1, wherein the at least one handling rod is operated by at least one ROV (Remoted Operated Vehicle) or by at least one diver or by at least one underwater drone.

3. Mooring link measuring tool according to claim 1, wherein the plurality of external diameter measurements of at least one mooring link comprises at least one of:
at least one measurement equal to the nominal external diameter value of at least one mooring link;
at least one measurement that represents 95% of the nominal external diameter value of at least one mooring link;
at least one measurement that represents 90% of the nominal external diameter value of at least one mooring link.

4. Mooring link measuring tool according to claim 1, wherein the at least one graduated fork comprises at least three calibration indications, including:
at least one calibration indication that represents 100% of the nominal external diameter value of the mooring link;
at least one calibration indication that represents 95% of the nominal external diameter value of the mooring link; and
at least one calibration indication that represents 90% of the nominal external diameter value of the mooring link.

5. Mooring link measuring tool according to claim 1, wherein the at least one adjustment plate is fixed in a plurality of positions of the graduated fork through at least one fixing means in at least one end of at least one of the at least one upper portion or at least one lower portion.

6. Method of measuring a mooring link using the mooring link measuring tool as defined in claim 1, the method comprising the steps of:
coupling at least one manipulator arm of at least one ROV (Remoted Operated Vehicle) to at least one handling rod;
position the mooring link measuring tool on the mooring link, between the center of the parallel body of the mooring link and the crown region of the mooring link;
moving the mooring link measuring tool against the mooring link until the mooring link locks between at least two arms of at least one graduated fork;
measuring at least one perpendicular diameter of the mooring link;
obtaining image of at least one adjustment plate positioned on the graduated fork.

7. Method of measuring a mooring link, according to claim 6, further comprising before coupling at least one manipulator arm of at least one ROV (Remoted Operated Vehicle) to at least one handling rod:
carrying out a visual inspection of a plurality of mooring links;
cleaning of at least one mooring link.

8. Method of measuring a mooring link according to claim 6, wherein the step of positioning the mooring link measuring tool on the mooring link, between the center of the parallel body of the link and the crown region of the link, comprises:
positioning the mooring link measuring tool on the mooring link sections to measure at least one perpendicular diameter of the link without twisting or tilting relative to the cross-section of the mooring link parallel body.

9. Method of measuring a mooring link, according to claim 6, wherein the step of measuring at least one perpendicular diameter of the link includes:
measuring at least three measurements of at least three links comprising:
at least one first link below the fairlead;
at least one second link 30 meters from the LDA; and
at least one third link intermediate between at least one first link and at least one second link.

10. Method of measuring a mooring link, according to claim 6, wherein the step of moving the mooring link measuring tool against the link until the link locks between at least two arms of the at least one graduated fork comprises:
moving the adjustment plate so that it slides along the two arms and is arranged in a position of the graduated fork.

11. Method of measuring a mooring link, according to claim 6, wherein the adjustment plate is positioned on the graduated fork at a plurality of measurement indications, wherein the plurality of measurement indications comprises a plurality of external diameters measurements of at least one mooring link.
